(19) United States
(12) Patent Application Publication
(10) Pub. No.: US 2015/0076314 A1
(43) Pub. Date: Mar. 19, 2015

(54) Devices for Optimising the Efficiency and for Protecting and Stabilising the Operation of Solar Modules Under Environmental Influences

(71) Applicant: MachtWissen. de AG, Bremen (DE)

(72) Inventor: Carsten Holze, Bremen (DE)

(21) Appl. No.: 14/349,127

(22) PCT Filed: Oct. 4, 2012
(86) PCT No.: PCT/EP2012/069645

§ 371 Date: Jul. 2, 2014

(30) Foreign Application Priority Data
Oct. 3, 2011 (DE) 10 2011 115 474.8

(51) Int. Cl. H02S 20/23; H02S 50/10; H02S 40/10

(52) U.S. Cl. CPC H02S 20/23; H02S 40/10; H02S 50/10; H02S 20/32
USPC 248/560

(57) ABSTRACT

The present invention is directed to a device (1) for protecting and for optimizing solar modules against wind and particles carried along in or by the wind, wherein the device comprises one or more partial bodies which are preferably constructed as flat or profiled panels/flaps, wherein a partial body is secured, preferably rotatably secured, by one or more fastening points (2) directly or, by means of an auxiliary device (3), directly or indirectly to the absorbing and/or reflecting solar module, and, for example, the at least one partial body is to be moved along or moved, respectively, in the operation area of the solar module in a uniform or non-uniform manner with respect to the system's own movement and accordingly protects and/or stabilizes the operation of the solar module actively and reactively with respect to the static and/or dynamic influence of the wind.

The present invention is directed to devices for optimizing efficiency and for protecting reflecting and absorbing solar collectors against environmental loadings by optimizing individual collector modules or combined collector module groups and collector module fields specifically with respect to flow.

### PRIOR ART

Solar power plants generally utilize concentrating, absorbing and/or reflecting modules in discrete configuration, but usually in array configuration, i.e., with a plurality of individual modules grouped together. These modules convert solar radiation into electrical energy directly, e.g., through photovoltaic cells, or indirectly, e.g., in that solar radiation which is concentrated on a heat exchanger by reflectors, for example, is converted into thermal energy and subsequently into electrical energy by means of known conversion processes.

In principle, the efficiencies to be achieved by solar power plants increase in the various embodiment forms thereof with the accuracy of tracking or minimizing of possible angular deviations of the solar modules with respect to the position of the sun. Losses are caused in particular by mean static angular deviations and additional dynamic deflection. In this regard, the occurring environmental influences—in particular the prevailing wind load—play an important role and cause corresponding deflections from the ideal position with respect to the sun depending on mean active variables (mean incident wind velocity, mean degree of turbulence and mean gustiness).

In this connection, concentrating technologies for bundling solar radiation particularly require a high accuracy with regard to the tracking of corresponding systems according to the position of the sun. These systems can be constructed as single-axis or two-axis tracking systems depending on the power plant technology employed. Depending on their construction, the solar modules can be displaced individually or serially in parallel by one or more drives. The choice of drive components is governed by the type of installation or system and by the acting environmental influences and design criteria resulting therefrom.

According to current standards, the design of solar power plants and individual components thereof, specifically the absorbing and/or reflecting modules for plant operation, is carried out using associated norms and rules for constructions works which specify the rated loads anticipated for environmental influences such as wind and snow. In some instances, model tests are conducted to verify these specifications.

In principle, the calculated loads to be used in the design of corresponding systems and corresponding permissible deformations can be divided into different classes, some of the most important of which are as follows:
(a) self-deformation of the absorbing and/or reflecting modules under their own weight in the entire operating angle range of possible tracking, i.e., from actual alpha=−30 (protected position) to alpha=180° (sunset position); in case of nontracking systems, the calculated loads of a static position may also possibly be used for this purpose; to determine the design loads, the effective inherent loads may be assumed to be quasi-static with known (vertical) force vector;
(b) the deformation of each individual collector module due to environment, in addition to inherent weight as described in (a): deformations or twisting of corresponding arrangements of collector modules marked substantially by wind loads; these loads and the deformations resulting therefrom can occur in a (temporally and spatially) unsteady manner;
(c) additionally occurring effects of the deformation in the above-mentioned classes due to temperature differences occurring over the course of a day and over the course of a year; as regards systems currently in operation, these effects are negligible compared to the deformations caused by the influence of wind.

Depending on the type of solar energy plant, the power-related specific design or dimensioning application for the individual modules or module groups composed thereof is given by the maximum deformations and twisting (or corresponding forces and moments) of the absorbing and/or reflecting collector module surfaces occurring individually or in combination with each other in accordance with the above-mentioned classes of self-deformation depending on the respective angular position in the operating angle area at the anticipated wind velocities in operation. In the case of non-tracking systems, i.e., static structures, combined deformations and corresponding rated loads of a static position in the operating angle range are utilized for this purpose.

In the target operating angle range, taking the maximum permissible wind velocities in regular operation as a basis, theoretically consistent maximum plant efficiency should be achievable while taking into account corresponding configuration criteria.

A further, safety-related configuration criterion for the solar energy installations, i.e., the individual absorbing and/or reflecting collector modules as well as the module groups composed thereof, consists in preventing damage to the installations over the course of years even under unfavorable environmental influences, i.e., for example, with wind velocities appreciably above operating wind velocities. In order to withstand these environmental conditions, solar plants are usually operated in so-called safety positions which, depending on operation, are characterized by relatively lower loads and corresponding torques compared to the operating configurations. Due to the maximum possible wind velocities, the deformations and associated loads and/or moments occurring in this position may be substantially greater or higher, than would be permissible for plant operation at the highest efficiencies. However, permanent, i.e., plastic, deformations should be avoided.

Viewing the design requirements for solar energy installations against the background of minimizing possible deformations and the direct influence thereof on the efficiency of installations during operation alongside the requirements of installations in the safety position leads to the conclusion that these requirements, based on the mode of construction, stem almost exclusively from the conditions and methods for reducing deformations during regular operation. Appropriately dimensioned and designed installations likewise withstand the maximum loads and moments occurring in the so-called safety positions, but only with increased elastic deformation.

The solar power plants and reflecting and/or absorbing solar collectors and module groups composed thereof which are designed with the above-mentioned view points in mind and optimized for operation will ensure that solar radiation is converted into electric or thermal energy at the theoretically highest efficiency.

In regular power plant operation, aside from the minimal deviations and/or deformations from the optimal geometry and/or optimal alignment of the individual modules and/or module groups composed thereof with respect to the position of the sun which are required for ensuring maximum overall plant efficiencies, many other diverse individual parameters of the overall power plant must be adapted and optimized. As concerns the conversion process (circular process for converting thermal energy into electrical energy), these parameters are known from conventional power plant operation and can be transferred directly to solar energy plants by analogy and/or theories on similarity.

A simple optimization taking into account all of the parameters resulting from the arrangement and configuration of aggregate solar module groups, the associated displacing units and/or tracking units and all of the components installed in the solar field will not be possible. There is a need over the long term to work this out for each individual configuration taking into account each of the individually contributing parameters relating to the mode of construction.

Together, the optimization and adaptation of all of the individual steps of regular operation will ensure an optimal overall efficiency and provide for minimized so-called power generation costs (costs of generating electrical energy) which will decide the success and utilization of corresponding technologies in the future.

When considering modern solar power plant systems, i.e., the principles actually underlying the configuration and design of these systems and of the individual collector modules and module units composed thereof, it will inevitably be concluded that corresponding structures have been regarded heretofore as construction works and, therefore, as static structures. However, upon closer analysis of their operation, it will be seen that as regards the tracking of the sun's position by the individual collector modules and the module units composed thereof, the sensitive surface in question is moved/displaced for converting solar radiation into thermal energy or directly into electrical energy. In plants with high energy efficiency, this takes place in at least one axis, usually in two axes, in the operating angle range with high tracking accuracy. In these power plant systems, depending on the mode of construction, up to 98% of the components whose design is affected by environmental influences consists of solar modules, i.e., a sensitive surface for converting solar radiation into thermal energy or directly into electrical energy, which surface can be moved and/or displaced in power plant operation. Therefore, the configuration of these systems heretofore based on the design principles of static constructions seems neither suitable nor optimal; because of the movement and/or tracking of the solar energy installations and the changes in plant geometry entailed thereby, the design principles to be applied vary within an enormous range of values.

Added to this, as it relates to real plant operation rather than theoretical design, are the environmental influences affecting the entire power plant which include the operating wind velocity and resulting loads and moments on the individual modules, and much more importantly on the module units composed thereof, which should be minimal—at least in theory—as a result of optimized configuration. In contrast to the theoretical approach which considers the forces and moments on the isolated modules and aggregate collector module units as static, interference loads (interaction between incident flow conditions and further parts of the installation) occur in addition to the cumulative individual loads in regular plant operation. Static interference loads and, depending on the mode of construction, also dynamic interference loads can be many times greater than the cumulative loading of the collector module units of the total power plant system assumed in theory, depending on the dominant operating conditions and associated environmental parameters in the operation area.

Accordingly, a detailed theoretical and empirical consideration of all occurring interferences and their effect on the efficiency of the entire power plant and the deformation of the individual collector modules and aggregate module units induced thereby will be indispensible in the future for configuration and dimensioning. Efficiencies which are optimized over the long term through minimal deformation of the components utilized in the modules and of the modules themselves can be achieved specifically through this optimizing step.

In technically comparable machinery, installations or equipment which can be operated with consistent system configuration and consequent geometry in different operation areas and/or application areas, e.g., at various angles of orientation, an individual adaptation and/or configuration is usually carried out for each individual operating point of the machine, installation and/or construction or equipment. In very rare cases, this configuration/optimization in the operation area will be implemented purely under theoretical and static view points, but almost exclusively under real, dynamic view points.

For present purposes, the airplane will be taken as a simple example. In an individual system configuration—by adapting correspondingly possible system parameters such as, for example, changing the angle of attack and/or the deployment of additional flap elements—the airplane must be able to take off at maximum weight, satisfy flight requirements in an energy-efficient manner and land under reduced load for at least twenty-five operating years, usually, however, for substantially longer periods of time.

Therefore, it is the object of the invention, depending on the prevailing, changing operating conditions and local environmental influences—particularly under strong, dynamic wind loads—on the solar power plant systems, i.e., individual solar modules and the module units composed thereof to ensure minimum deformations and deviations from the ideal tracking angle and/or sun position angle of single-axis tracking and two-axis tracking modules and aggregate module units due to environmental influences and, therefore, to ensure a maximum efficiency of the construction for each individual operating situation and/or operating load. As it relates to the individual solar modules and the module units composed thereof, this means that minimal self-deformations of the above-mentioned classes and further deformation mechanisms in the operation area must also be ensured for the actual case of operation under boundary operating conditions that may possibly occur.

The above-stated object is met in the collector modules and collector structures of the type mentioned above in that one or more rigid and/or movable devices 1 which can be connected directly by one or more flanging points 2 fixedly and/or loosely to the construction or additionally through the use of one or more connection elements 3 fixedly and/or loosely to the construction and/or which can be mounted indirectly or directly at the construction by possible auxiliary devices 4 and are statically and/or uniformly or non-uniformly correlated with the operation of the construction in a suitable manner ensure, as required for optimal operation, optimal structure loadings and/or moment loadings for the individual solar modules and aggregate module groups, which structure loadings and/or moment loadings are triggers for the self-deformations of the above-mentioned classes in the operation area and can accordingly result in substantially reduced efficiency. Through the use of one or more additional devices for receiving or securing solid, liquid or gaseous substances 5, additionally necessary structure loadings and moments for optimizing the overall system can be provided for operation as well as for the safety position. FIG. 1 shows a possible construction of a solar-thermal collector module with two off-center-mounted devices according to the invention.

The device can be constructed in accordance with the anticipated loadings as active or passive manipulator in a simple geometry and/or in a geometry adapted to the specific application and, in relation to the specific application, i.e., individual collector modules and/or the module units composed thereof, can be moved therewith uniformly in fixedly mounted mode of construction or in uniform or non-uniform correlation to the operating movement and/or can also be displaced in isolation.

Depending upon the mode of construction, the device can move in a preferred direction, i.e., around a main axis of rotation of the individual modules or aggregate module groups, and can be moved around further axes of rotation and/or only around further axes of the system in a suitable manner so as to be correlated statically and/or uniformly or non-uniformly with the operation of the construction.

In regular, unperturbed plant operation, the rigid and/or movable device forming a unit with the individual collector modules and/or the module units composed thereof ensures the optimal efficiency of the overall construction of the concentrating, absorbing or reflecting modules. With increasing influence of the environmentally relevant parameters, i.e., particularly with increasing influence of wind, and depending on the respective module operating point and the deformations, force and moments occurring as a result as active forces which are perceived as resulting in reduced output, the moved-along rigid devices, whose positive influence on efficiency must be ensured in the preceding optimizing process, and the moving devices can be utilized by means of suitable movement in the manner optimally adapted to the varying environmental parameters to reproduce the optimal efficiency, i.e., bring about corresponding resistance forces, of the individual modules and/or the module units composed thereof.

This means that, for example, for the specific application where at high incident wind velocity, e.g., in a parabolic trough collector field which comprises rows of aggregate individual collectors, each of which is moved by one or more movement units, a twisting occurs as a result of the summing of the respective induced individual torques of the modules taking into account the material-specific parameter. Individually for each module and for the aggregate module group. Corresponding twisting values will be minimal for the modules which are located in direct mechanical connection to a fixed bearing or drive and/or a movement unit. This results from the twisting of the individual, i.e., first, module at the fixed bearing itself. As the number of modules increases and with the increase in torque which is additionally induced as a result, the twisting angle in identical collector modules (and possibly additionally integrated add-on parts) is disproportionately greater. Depending on occurring static wind loading, absolute twisting values for the aggregate module units are achieved which sharply reduce the individual collector efficiency or even leave it at zero. Rigid and/or moving devices of the type mentioned above would be actively moved along for this case or, as passive manipulators, would generate corresponding resistance forces and resistance moments (generation of forces and moments which are directed counter to the original component). As a result, twisting was successfully reduced or, depending on resources for controlling and adjusting the devices, even eliminated and, therefore, an optimized efficiency of the entire system of aggregate module units was achieved.

Further, in particular, the moving devices, depending on occurring environmental parameters and, in this case, particularly when a fixed or variable threshold, e.g., incident wind flow vector, is exceeded, can be used as passive control element, e.g., the movement of the concentrating, absorbing or reflecting modules in discrete configuration or in array configuration into a previously determined position, usually for protecting the overall construction. Compared to the systems in operation heretofore which configure their drive systems in terms of power to the operating condition of maximum forces, a drive can generally be dispensed with if necessary by making use of the occurring incident wind flow vector in combination with the uniformly or non-uniformly moving devices in the operation area and the forces and torques which are therefore dynamically generated. The occurring environmentally specific reaction forces overcompensate for this case of reaction forces. In this case, only a brake is required for arresting an individual collector module or module groups composed thereof in a predetermined position.

For the case of application taken by way of example, this means that at a high incident wind velocity, e.g., in a parabolic trough array which comprises rows of individual collectors, each of which is moved by one or more movement units by means of the active movement of a manipulator, torques can be generated which reinforce the torques generated by the drive, so that corresponding module units and/or module groups composed thereof can be moved partly or entirely without additional drive into their safety position (end stop).

Based on the mode of construction, solar power plant systems, depending on geometric construction, i.e., using specific reflecting and/or absorbing modules and the fastening systems and holding systems thereof, can be impaired not only by static forces and deformations resulting therefrom as was described above, but also by unsteady forces and/or unsteady excitation of vibrations. These constructions are substantially excited by the interaction between the geometry and environmental influences. The unsteady separation tendency of different geometric bodies, in the simplest case a panel or, e.g., a right circular cylinder, is mentioned by way of example. Efficiency losses occur principally due to the vibrations excited by dynamic forces and the resulting dynamic deformation of the modules and/or aggregate module groups.

The devices according to the invention, in rigid or flexible manner, passively moved along or actively controlled, can sharply suppress or possibly completely prevent the occurring dynamic effects analogous to the functioning explained above for the static case. Experiments conducted for solar-thermal and photovoltaic applications show a reduction in alternating loads of over 90%. FIG. 5 shows this by way of example for a heliostat and/or PV system. In the at-risk elevation angle ranges beta, corresponding device 1, partial body I, prevents the dynamic separation at the leading edge of the construction, and therefore the ensuing excitation of vibrations of the entire construction, through flow deflection. By means of additionally (passively or actively) moved devices 1, partial bodies II, the dynamic structure loads and torque loads brought about by the flow around the construction in its entirety can be completely suppressed for the operation area and in the safety position. The devices 1, partial bodies III, stabilize the entire system and the tracking of the entire system and accordingly ensure that the separating flow can exert the least possible dynamic effects on the adjacent or downstream systems.

For all applications for optimizing solar modules, one or more rigid and/or moving devices can be used. The corresponding possibility for use of the device according to the invention has been described in the preceding paragraphs and will be illustrated once again in an exemplary fashion as embodiment examples referring to the appended drawings.

It is clear from the foregoing functional description of the use of the device with associated exemplary embodiment examples that a virtually complete protection of the solar modules in the power plant installations can be achieved by the device and additional connection elements. Aside from increased system security, this also, above all, affords the possibility of a simpler system construction and of highly optimized plant operation.

In order to make full use of these advantages, it is necessary to appraise the possible optimization potential already during the conceptual planning phase of the solar power plant and to incorporate this directly into the design and subsequent construction. Studies for appraising the effect of using the device according to the invention in the subsequent individual modules and/or aggregate module groups can be carried out already in the planning phase for the solar power plant in model scale. Accordingly, as in the development of aircraft, qualitative and quantitative design and configuration basics can be worked out. Aside from insights into the phenomenological effect of the device, corresponding results will give an indication above all about the possible quantitative optimization potential of the individual modules and aggregate module groups compared to plants which are not optimized.

With respect to technical embodiment, the device can be directly and/or with the assistance of possible auxiliary devices directly or indirectly fixedly and/or flexibly connected to the construction. In this regard, the device or possibly also a plurality of devices can also be mounted in combination with additional connection elements in any orientation direction and in different axes. These axes can, but need not necessarily, coincide with the movement axis or movement axes of the solar modules or of the module groups composed thereof.

In use, the device, whose essential function is to influence the flow around the solar module and module groups composed thereof, can be provided as rigid construction which is rigidly fastened to the solar module and moves along in a manner analogous to the movement of the solar module. During operation of the solar modules, various active forces are exerted on the solar module by the change in installation angle in one or more axes of rotation due to the change in the angle of the sun's position and corresponding tracking through the environmentally specific influence and the change thereof depending on angular position. Therefore, the use of the device according to the invention as active device is a very useful variant.

In principle, the device can be constructed symmetrically or asymmetrically with respect to the basic axes of the system. Measurements of prototypes have shown that precisely the asymmetrical construction, versus the symmetrical construction, has substantial advantages with respect to the loads and torques induced by environmentally specific influences as well as the reaction forces and reaction moments which are brought about. In extension of the asymmetrical construction, the device and/or variants of the device can be constructed and/or mounted at the solar module or an auxiliary device in a variable manner with respect to their geometry and height. By means of additional auxiliary devices, the height of the suspension can be adapted or varied relative to the load in question. Above all, this embodiment can compensate for the non-uniform incident flow, i.e., differences in the incident flow velocity depending on the incident flow height (ground boundary layer formation has considerable influence on the incident flow conditions), which can be identical to the respective height of the solar module.

The use of lightweight structures and the modern composite materials used for this purpose guarantee maximum optimizing effect with minimal additional structure loads and torque loads through the construction itself. Further, very simple systems can also be produced from metallic materials or plastics and, of course, also from combinations of the two. Aside from this, weather-resistant and UV-resistant materials also guarantee long life cycles and high availability of protection in addition to the possible mechanical stability.

As was already described, the technical embodiment of the device can be adapted individually to the anticipated load and the reaction loads and reaction moments relating thereto. Further, through creative constructional details, the device, i.e., mounting at the solar module and/or auxiliary devices of the solar module, can be used as an additional reinforcement element with the possibility of adapting the spatial position through possible deformation through the influence of the environmentally specific influence as well as active actuating components.

The airplane can once again be used as an example of a technical embodiment. By means of using miniaturized trailing edge flaps which are deployed for takeoff and landing, i.e., in the high lift phases at the trailing edges of the flaps, the torsional stiffness of the highly loaded flaps can be greatly increased while greatly increasing lift at the same time.

The device according to the invention can be protected against virtually all environmental influences in operation and, further, also in possible protection positions when using one or more additional connection elements and possibly one or more additional connection elements for fastening the latter which can be mounted individually or as a total structure at the solar module.

In this connection, the possibility of combining a rigid, full-surface device according to the invention such as was described in the preceding paragraphs in combination with additional connection elements will be considered by way of example. These connection elements can be used individually and in combination as protection (flap or wrapping) for the modules so that they are protected externally against wind, e.g., also against objects and/or media carried along by the wind, hail and even possibly against solar radiation (UV protection).

The device according to the invention can be segmented individually or in combination with additional connection elements and constructed in different geometric embodiment forms. The integration of sheet elements, mesh elements, netting elements or fence elements which can also be segmented in horizontal and vertical axis and/or shaped in an inhomogeneous arrangement further allows the working surface of the devices to be individually adjusted to the anticipated load, i.e., the anticipated wind load. A plurality of elements can be combined with one another in vertical direction as well as in flow direction in order to produce an optimal effect with the least possible structural weight.

From the view point of fluidics, precisely the inhomogeneities and asymmetries in the construction of the individual solar modules and/or groups of aggregate modules and devices which are indirectly or directly mounted at the latter have a positive effect on the optimization of the efficiency and the stabilization of operation.

The use of devices themselves and/or of the fastening points of the devices to the horizontal and vertical edges of the modules offer additional protection and functionality.

For example, the devices can be used specifically to reduce or completely block the ground clearance of the module in the different movement axes. In accordance with the geometry and construction of the device, this can also be used as mechanical stop, buffer or damper. Moreover, owing to the asymmetrical shape of the device, it can be used in combination, i.e., by using the actual actuator or by using the drive of the solar module itself, to produce and/or restore the ground clearance, e.g., by filling or deposition of granular media, and for displacing and/or transporting objects in the effective range of the module.

Aside from ensuring the protection of the absorbing and/or reflecting modules, the devices and also the auxiliary devices for receiving and/or securing or receiving and securing solid, liquid or gaseous materials can also be used for paraxial guidance of diagnostic, measuring and controlling systems as well as for cleaning the surfaces of corresponding modules. Further, the device can also be used as a guide and/or for positioning systems that are not permanently located in the effective range of the solar module.

The device according to the invention which, as was described above, can also be constructed in partial bodies or partial surfaces can be constructed in the simplest case as simple, planar panels. The latter is rigidly or swivelably, i.e., movably, fastened to the solar module directly by means of one or more fastening points or indirectly by means of an auxiliary device.

It is known from fluid mechanics that, depending on the incident flow conditions or circulating flow conditions with respect to the device according to the invention, i.e., position and/or orientation of the device, i.e., taking the example of the above-mentioned simple planar panel, in relation to the incident flow vector, the flow around the panel only contacts both sides of the panel in a very limited area, i.e., with very slight angular deviations of the longitudinal orientation of the panel relative to the incident flow direction, and therefore bring about maximum stabilization of the circulating flow and the reactive forces associated therewith. Outside of this angular area, the flow separates when impinging on the “sharp” edge of the device according to the invention, and a zone of separated flow occurs instead of the potential accelerated flow which would normally be present on the so-called suction side. It follows that in order to further expand and optimize the efficiency of the device according to the invention, the device can be added to and/or constructed in its entirety in different geometric shapes. The right circular cylinder is mentioned here as exemplary shape. A right circular cylinder would ensure a noncritical separation of the flow in a further range of variations of the possible incident flow vector of the flow and device according to the invention. However, apart from this, all conceivable standard geometries and specific profile geometries can also be used in order to ensure a stable flow around the device according to the invention in the entire operating angular range of the solar module and, in so doing, possibly to bring about maximum reaction moments, in addition, i.e., for example, through the influence of the wind. Depending on the construction and on the reactive forces to be generated at the solar module, the simple planar panel can also be constructed in a segmented manner. In addition, by using inhomogeneities, e.g., inserting holes and/or integrating fence structures or mesh structures, the ratio of flow deflection to through-flow of the respective simple planar panel can be varied and adapted to the respective requirements.

In this regard, as was already described, the device according to the invention can also have a non-uniform extension and/or shape with respect to the corresponding spatial directions of orientation. As a practical embodiment example, let it be assumed here that a rigid or flexible flap element is mounted on the so-called suction side of a parabolic trough collector, i.e., on the side of convex curvature, so that the flow, depending on the operating parameters, is deliberately stabilized and guided or so that the position of the flow separation is fixed and a stabilization and optimization of the circulating flow is accordingly ensured. In this case, as has been described, individual parts of the flap can be constructed from inhomogeneous materials. The use of different geometries and the combination thereof allows an individual stabilization of the solar module and, therefore, a maximum protection to be adjusted.

The construction of the device according to the invention can be supplemented in a simple or specific geometrical construction through additional connection elements which can be outfitted in turn with additional possibility of partial through-flow, not homogeneously but rather, for example, by integration of mesh elements or fence elements. This additionally optimizes and stabilizes the flow. In addition, by using, e.g., simple protective netting as connection elements, the solar module rotates into these connection elements through its own rotation in the operating space and is therefore virtually completely protected from external environmental influences.

However, the construction of the device according to the invention as a right circular cylinder for receiving or securing or receiving and securing solid, liquid or gaseous materials can also be mentioned here as a practical embodiment example. Thus the device according to the invention, based on the requirements in the field of solar modules, can be outfitted with additional mass and suspended at different heights at the horizontal supporting structure of a heliostat through the use of additional connection elements, for example, a wind protection mesh. The flow around the heliostat is accordingly extensively modified and stabilized depending on the elevation angle of the solar module and the ground clearance adjusted in so doing. Loads and induced torques are appreciably reduced.

The use of and application of the device explained within the framework of the description of the device according to the invention and the effect thereof i.e., the stabilization and resulting optimization of the flow around the solar modules and the protection of the latter, relate on the one hand to the solar modules themselves and on the other hand to the operation area of the individual solar modules and, finally, also to the field of application in the power plant field of solar modules.

It is apparent from the consideration of individual solar power plants and entire power plant fields that individual solar modules can be stabilized and protected primarily through local modifications, e.g., through the use of the device according to the invention, and can therefore undergo optimized operation. Accordingly, particularly in the at-risk areas of corresponding power plant fields, appreciable gains in efficiency and a generally optimized operation with respect to individual solar modules can be achieved.

As concerns the individual solar module, the use of the device according to the invention is limited to the operation area of the solar module. On one hand, this means that the device according to the invention can be secured directly rigidly and/or flexibly to the solar module. However, it is also possible to secure the device according to the invention to the solar module or in the operation area of the solar module, respectively, directly or indirectly by means of one or more auxiliary devices. In this connection, the operation area of the solar module typically includes the area which would be covered by twice the respective longest basic dimension, i.e., the reference length comprising length, width or height and/or diameter or radius of the module irrespective of the one or more rotational axes, respectively, of the solar module in the different possible spatial directions.

Further advantages, features and details of the invention follow from the claims and subclaims in which particularly preferred embodiment examples are described in detail with reference to the drawings.

The features depicted in the drawings and mentioned in the claims and in the description can be crucial to the invention individually in themselves or in any combination.

Drawings 1 to 7 describe typical embodiment forms of the device according to the invention in exemplary solar modules. Drawing 8 shows two possible embodiment forms of the device according to the invention as simple planar, profiled panel on a solar-thermal collector module.

FIG. 1 is a side view showing by way of example the construction of a combination of the device 1 according to the invention for optimizing individual solar modules and aggregate module groups against environmental influences, particularly wind, with a rigid assembly (partial body a) which is moved along with and secured to a module and an assembly (partial body b) which is movably moved along with the module in a uniform or non-uniform manner. In the protected position of the individual solar modules and aggregate module groups, the device 1, partial body b, acts as protection for the reflecting or absorbing modules of the collector close to the ground against particles and objects entrained in the flow. Device 1, partial body a, provides for a consistent, optimized, stabilizing flow around the upper edge of the collector. In a selected operating position, device 1, partial body b, provides for minimizing the underflow and smaller structure loads brought about thereby and primarily torques of the collector system; the device 1, partial body a, simultaneously generates a counter-torque by means of additional flow deflection. This guarantees optimized self-deformations of the total system at the highest possible efficiency.

FIG. 2 is a side view showing the construction of the device 1 according to the invention for optimizing individual solar modules and aggregate module groups against environmental influences, particularly wind, in an assembly which is indirectly secured to the solar module and which is movably moved along in a non-uniform manner. In this case, the device 1 is mounted in the effective range of the solar module by means of an auxiliary device 4 mounted on the ground. In the protected position of the individual solar collector modules and aggregate groups of collector modules, the device acts as protection for the reflecting or absorbing modules of the collector close to the ground against particles and objects entrained in the flow. In the operation area, the device is moved along in a non-uniform manner such that an optimized, stabilizing effect of protection against environmental influences, e.g., wind, and particles entrained in the flow is realized with minimal impairment, e.g., due to shading.

FIG. 3 shows a side view of the construction of the device 1 according to the invention in sunrise configuration (part I of the drawing) and protection configuration (part II of the drawing). Together with the device 1 for optimizing, which device 1 is constructed as device for receiving or securing, or receiving and securing, solid, liquid or gaseous materials 5, individual connection elements 3 or a plurality of connection elements 3 are fastened at different fastening points 2 to the individual solar module which is embodied in a design comprising framework, supporting structure and the actual reflectors. Underflow under the collector system is completely or partially prevented for normal operation as well as in the wind-protected position. The shape and mass of protection can be varied in virtually any manner by the filling level of the device for receiving the materials 5. In a functionally dependent relationship, the degree of blocking of the device for receiving gaseous, liquid or solid materials and the corresponding filling level also changes the protection against wind loads of different levels. Additionally, through the volume of the device for receiving gaseous, liquid or solid materials, it is possible to use the wind protection as storage and movement in conjunction with a storage. In the simplest case, the device 5 for receiving or securing, or receiving and securing, gaseous, liquid or solid materials can also be constructed as a simple mass element.

Part 2 of the drawing shows the use of the device 1 combined with a plurality of connection elements 3 which are connected to the solar collector by a plurality of fastening points 2. As a result of the collector rotating into the connection elements 3 in conjunction with the device 1 for optimizing, a protection is ensured for the collector as well as the add-on parts thereof. In the embodiment example, the device provides for receiving or securing solid, liquid or gaseous materials 5.

FIG. 4 shows a side view (part I of the drawing) and rear view (part II of the drawing) of the construction of the device 1 according to the invention at a solar module system comprising a torque pipe and the actual reflector in a general operating configuration. A connection element 3 which is constructed as a lattice structure by way of example is fastened together with the devices for receiving or securing, or receiving and securing, gaseous, liquid or solid materials 5 at three fastening points 2 to the torque pipe of the collector element. The shape and mass of protection can be varied in virtually any manner by the filling level of the device for receiving the materials. In a functionally dependent relationship, the degree of blocking of the device for receiving gaseous, liquid or solid materials and the corresponding filling level also changes the protection against wind loads of different levels. Underflow under the collector system is completely or partially prevented. Additionally, through the volume of the device for receiving gaseous, liquid or solid materials, it is possible to use the wind protection as storage and movement in conjunction with a storage. In the simplest case, the device for receiving or securing, or receiving and securing, gaseous, liquid or solid materials can also be constructed as a simple mass element.

FIG. 5 shows the construction of the devices 1 according to the invention at a solar module system comprising a torque pipe and the actual reflector in a general operating configuration mounted centrally in side view (part I of the drawing), mounted off-center (part II of the drawing) and the overall construction (part III of the drawing) in rear view. The devices which are mounted centrally and off-center are constructed, for example, as lattice structure of a mean blocking degree of 30%. They can be mounted directly at the solar module, as is shown in the example, or indirectly by means of an additional auxiliary device 4. Further, the devices can be constructed as arrangements of simple mass elements and/or as devices for receiving or securing, or receiving and securing, gaseous, liquid or solid materials 5. The rear view of the construction shows, as embodiment example, segmented optimization device mounted at the collector module so as to be rigidly moved along (partial body a) and movably moved along in a uniform or non-uniform manner (partial body b). It is especially clear from the example in the rear view that all of the sub-components which are used, i.e., the device 1 according to the invention which is constructed as devices for receiving or securing, or receiving and securing, gaseous, liquid or solid materials 5, and the connection element 3 can be segmented and constructed in an inhomogeneous manner, in this case through the use of lattice structures. In the protected position of the individual solar modules and aggregate module groups, the device (partial body b) acts as protection for the reflecting or absorbing modules of the collector close to the ground against particles and objects entrained in the flow. Device (partial body a) provides for a consistent, optimized, stabilizing flow around the upper edge of the collector. In a selected operating position, device (partial body b) provides for minimizing the underflow and smaller structure loads brought about thereby and primarily torques of the collector system; device (partial body a) simultaneously generates a counter-torque by means of additional flow deflection. Depending on the direction of incident flow, device (partial body c) provides for a uniform flow around the top and bottom of the solar collector with reduced or completely suppressed dynamic flow separation. This guarantees optimized self-deformations of the total system at the highest possible efficiency.

FIG. 6 shows the construction of the device according to the invention at a solar module system comprising a suspension/rotational axis and the reflecting and/or absorbing surfaces in a general operating configuration in side view with wind on the front (part I of the drawing) and wind on the back (part II of the drawing). In this embodiment example, the off-center-mounted devices 1 according to the invention are located both on the front side and back side and at the upper and lower edge (transferred to a three-dimensional construction, additionally also possibly at both peripheries) of the solar module system and can be constructed so as to be rigidly moved along and moved along movably and/or in a uniform or non-uniform manner. They can be segmented. In the various incident flow positions, they can be moved by the occurring wind forces, possibly also passively. Depending on the blocking carried out, they provide for additional or reduced ventilation and accordingly have a considerable influence on the torques of the construction occurring in the different axes. In the case of incident flow at incident flow angles and/or yaw angles, the device 1 (part 1 of the drawing, partial body a) mounted close to the ground provides for an uncritical separation behavior of the flow, i.e., minor unsteady effects at the leading edge. In this case, because of the large relative lever arm with respect to the axis of rotation, even very small acting forces have great effect on the occurring torque and deformation of the structure, i.e., the construction. Device 1 (part 1 of the drawing, partial body c) provides for the stabilization of the collector system in regular operating configuration and for the smallest possible structure loadings and torques for the safety position. All of the devices can also be segmented and constructed as lattice structures. Individually or collectively, the devices 1 (part 3 of the drawing, partial bodies a and b) can be used as auxiliary device for guidance 6 and/or for support for additional devices and equipment 8 which is not permanently located in the effective range of the solar module.

As mentioned, the devices or partial bodies 1 according to the invention can be constructed in different variants, for example, as flat panel or flap (which then have a predetermined width and height)—see, e.g., FIG. 8a—or as profiled and/or curved panel/flap as is shown, for example, in FIG. 8b. As mentioned, the device or partial body according to the invention can also be formed as a mesh structure. Specifically, this refers not to a closed panel/flap or profile, but means that a flat and/or profiled and/or curved panel/flap or the like has openings. A mesh structure of this kind can also be provided, for example, by using a frame in which a lattice structure (e.g., wire) is inserted; this lattice structure can in turn be provided with a covering of flexible material (e.g., woven cover, fabric cover, etc.) depending on the aimed-for effects with respect to propulsion, lift, etc.

The partial body 1 according to the invention can be rigidly secured to the solar module or is arranged at the solar module by means of a joint and can be moved into a selected angular position relative to the solar module via a device, e.g., of a motor device on electric motor (hydraulic operation). For example, FIG. 1a shows two partial bodies 1a and 1b according to the invention. Partial body 1a is oriented somewhat horizontally, i.e., approximately parallel to the incident wind, while partial body 1b is oriented vertically, i.e., practically transverse to the wind direction. The flow of wind around the solar module can be selectively adjusted by means of the different orientations such that the wind loads on the solar module and the entire solar arrangement are reduced and such high incident wind forces no longer act on the entire solar module.

The further drawings also show that the partial bodies 1a, 1b, 1c, 1d, etc. according to the invention can be oriented at various angles to the surface of the solar module. As is shown in the various embodiment examples, e.g., also in FIGS. 6b, 6c, 7a, 7b, a plane-oriented solar module can also have openings 10 which preferably extend over the entire width or partial width of the solar module and which can be closed by means of the partial bodies 1a to 1f according to the invention (this is clearly shown in FIG. 6b, above, by partial body 1d, or the openings 10 are left open as is also shown in FIG. 6a by partial body 1e).

Depending on the extent to which an opening 10 is closed by the partial body 1, the flow of air around or through the opening 10 can also be influenced in an optional manner to reduce the entire wind load on the solar module.

The invention according to the present application also includes a method for the protection and optimization of solar modules against environmental influences, e.g., against wind and the particles and objects transported in or by the wind, by means of the device according to the invention which can comprise one or more partial bodes as is described in the present application.

### KEY TO THE REFERENCE NUMERALS

1a partial body a
1b partial body b
1c partial body c
1e partial body c
2 fastening point
3 device according to the invention
4 connection element
5 device for receiving and/or securing
6 axis of rotation
7 solar module
8 removable device
9 right circular cylinder
10 lining
11 planar panel
12 profiled panel
13 auxiliary device mounted on the ground
14 auxiliary device for guiding

### DESCRIPTION OF THE PARTS OF THE DRAWINGS

FIG. 1a:

Drawing part I: Side view of solar collector in protected position outfitted with optimizing devices (partial body or partial bodies is or are rigid or movable)

FIG. 1b:

Drawing part II: Side view of selected operating configuration outfitted with optimizing devices (partial body or partial bodies is or are rigid or movable)

FIG. 2a:

Drawing part I: Side view of selected operating configuration with optimizing device arranged in effective range of the solar collector

FIG. 2b:

Drawing part II: Side view of selected operating configuration with optimizing device arranged in effective range of the solar collector

FIG. 3a:

Drawing part I: Side view of sunrise configuration

FIG. 3b:

Drawing part II: Side view of collector in safety position

FIG. 4a:

Drawing part I: Side view of operating configuration

FIG. 4b:

Drawing part II: Rear view of operating configuration

FIG. 5a:

Drawing part I: Side view of operating configuration with centrally mounted device (partial body or partial bodies is or are rigid or movable)

FIG. 5b:

Drawing part II: Side view of operating configuration with off-center-mounted device (partial body or partial bodies is or are rigid or movable)

FIG. 5c:

Drawing part III: Rear view of operating configuration with centrally mounted device according to drawing part I (partial body or partial bodies is or are rigid or movable) FIG. 6a:

Drawing part I: Side view of operating configuration of a two-axis tracking configuration of a solar collector/reflector with off-center-mounted optimizing devices with front-side incident flow (partial body or partial bodies is or are rigid or movable)

FIG. 6b:

Drawing part II: Side view of operating configuration of a two-axis tracking configuration of a solar collector/reflector with off-center-mounted optimizing devices with rear-side incident flow (partial body or partial bodies is or are rigid or movable)

FIG. 6c:

Drawing part III: Side view of configuration of a two-axis tracking configuration of a solar collector/reflector with mounted equipment not permanently located in the effective range of the solar collector/reflector (partial body or partial bodies is or are rigid or movable)

FIG. 7a:

Drawing part I: View of the device as right circular cylinder for receiving and/or securing solid, liquid or gaseous materials in conjunction with a connection element which is constructed as a mesh structure for stabilizing and for protecting a heliostat system

FIG. 7b:

Drawing part II: View of a triangular, planar mesh structure for lining and for protecting a heliostat system/concentrating photovoltaic system which receives a lateral incident flow at an elevation angle of 90°

FIG. 8a:

Drawing part I: View of a simple, planar panel which can swivel around two pivots on the same side, i.e., mounted symmetrical to the convex side of a parabolic trough collector

FIG. 8b:

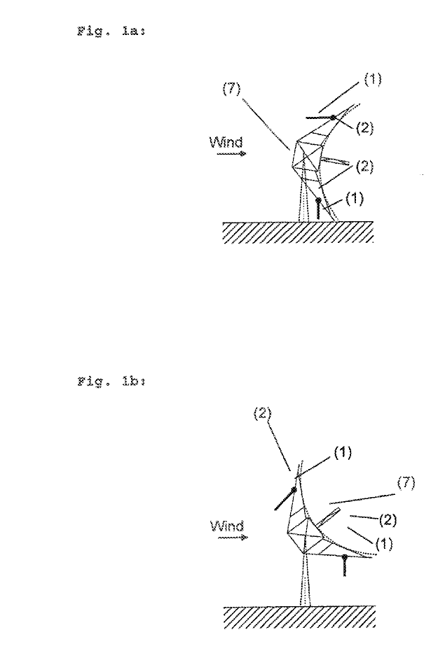

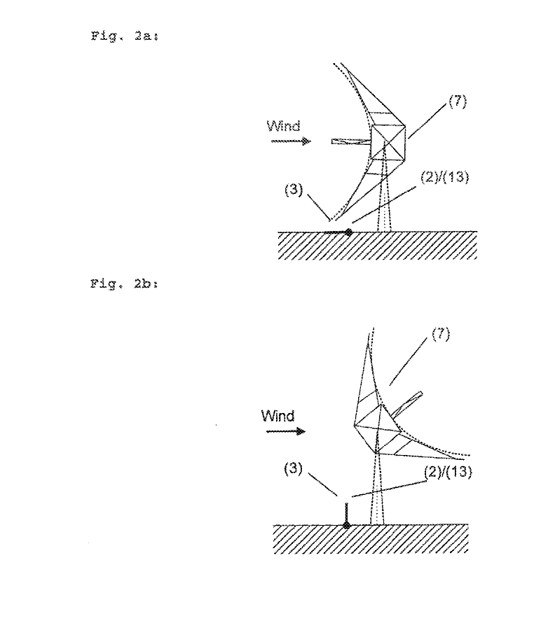

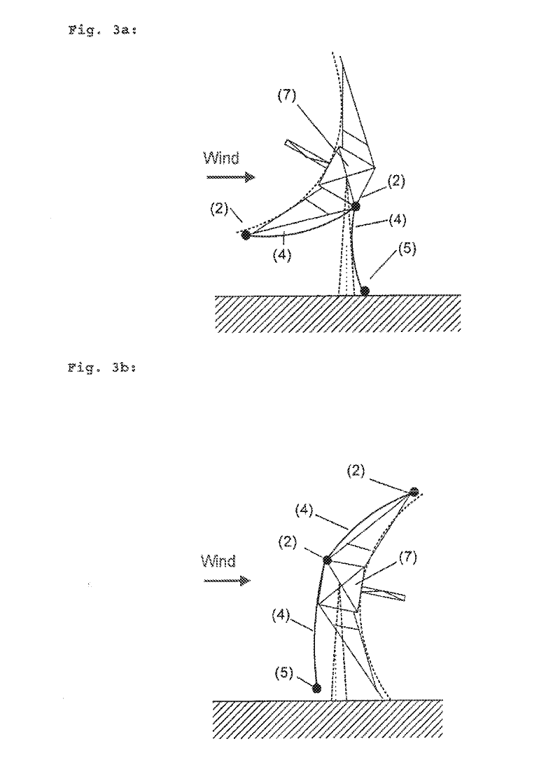

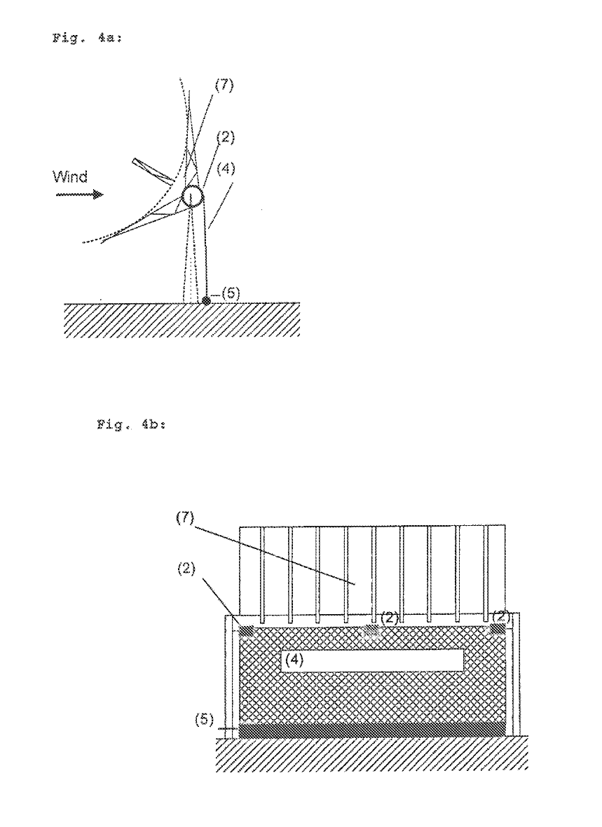

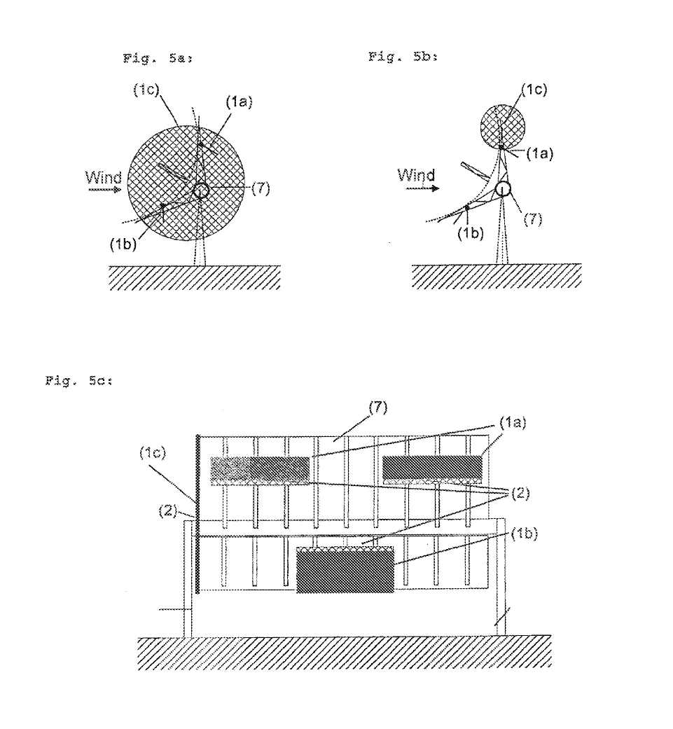

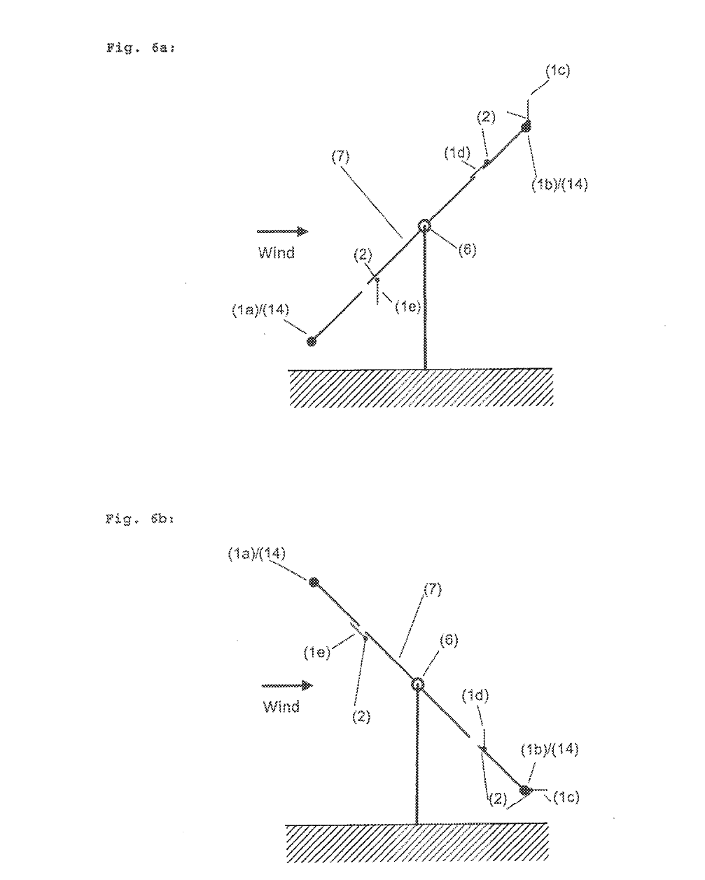

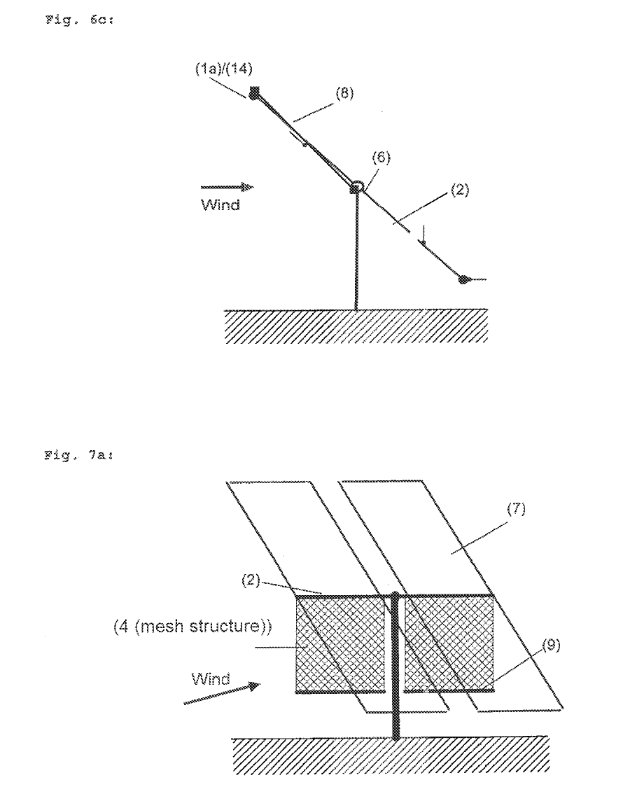

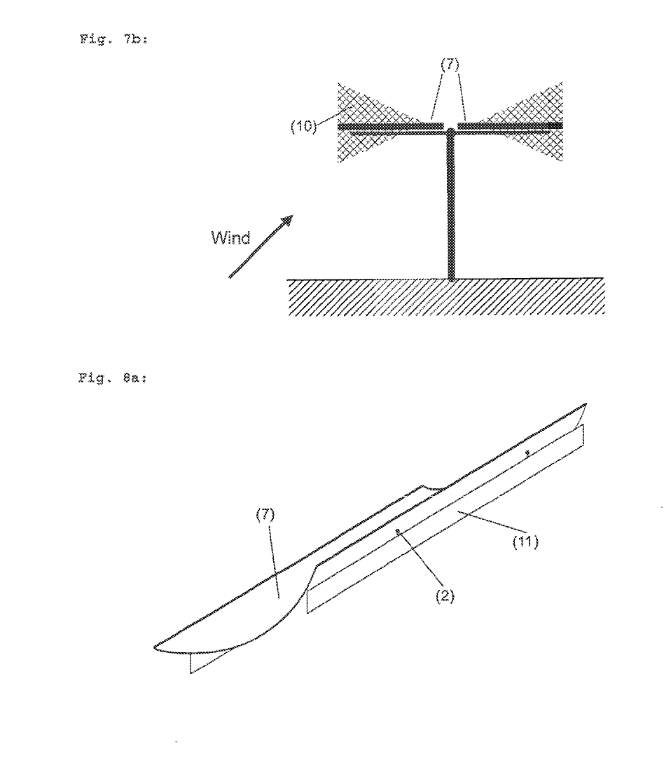

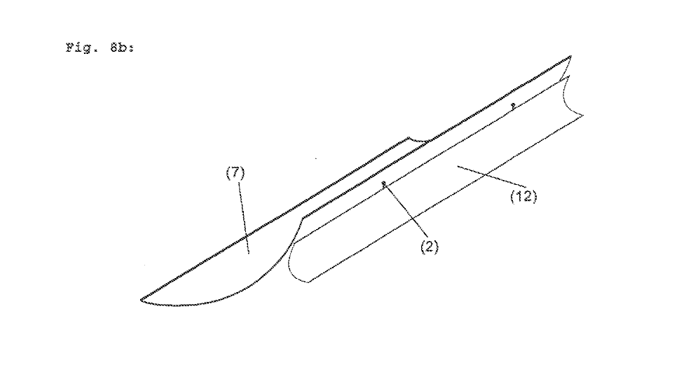

Drawing part II: View of a profiled panel which can swivel around two pivots on one side, i.e., mounted asymmetrical on the convex side of a parabolic trough collector

1. Device (1) for protecting and for optimizing solar modules against wind and particles carried along in or by the wind, wherein the device comprises one or more partial bodies which are preferably constructed as flat or profiled panels/flaps, wherein a partial body is secured, preferably rotatably secured, by one or more fastening points (2) directly or, by means of an auxiliary device (3), directly or indirectly to the absorbing and/or reflecting solar module, and, for example, the at least one partial body is to be moved along or moved, respectively, in the operation area of the solar module in a uniform or non-uniform manner with respect to the system's own movement and accordingly protects and/or stabilizes the operation of the solar module actively and reactively with respect to the static and/or dynamic influence of the wind.

2. Device according to claim 1, characterized in that generated forces and/or moments can act in the direction of or opposite to the direction of the causative environmental influence.

3. Device according to claims 1 and 2, characterized in that it can be rigidly or flexibly mounted.

4. Device according to claims 1 to 3, characterized in that it can be constructed symmetrically or asymmetrically with respect to the solar module and, in this connection, can itself have a uniform or non-uniform geometry in one or more spatial directions.

5. Device according to claims 1 to 4, characterized in that it can be mounted and moved in one or more additional axes.

6. Device according to claims 1 to 5, characterized in that it can change its geometry and/or attitude under load, i.e., through acting environmental influences.

7. Device according to claims 1 to 6, characterized in that it can be constructed in a segmented manner.

8. Device according to claim 1 to claim 7, characterized in that it can be constructed in the effective range of the collector so as to be statically variable in height or, through its own movement or collector movement, dynamically variable in height.

9. Device according to claims 1 to 8, characterized in that it can change the stiffness(es) of the solar module in one or more axes.

10. Device according to claims 1 to 9, characterized in that it can be constructed of lightweight components and lightweight materials (e.g., CFRP, GRP, aramid, aluminum and composite structures thereof); alternatively, inexpensive alternatives of the device comprising metallic materials and/or plastics can also be used.

11. Device according to claims 1 to 10, characterized in that it can be connected to additional connection elements (4).

12. Device according to claims 1 to 11, characterized in that it can be constructed inhomogeneously to vary the degree of blocking; optional combinations of blocking can be constructed by integrating gaps, slits, holes and/or integrating sheet elements, netting elements, mesh elements or fence elements of varying degrees of blocking.

13. Device according to claims 1 to 12, characterized in that it can be constructed as device (5) for receiving or securing, or receiving and securing, solid, liquid or gaseous materials.

14. Device according to claims 1 to 13, characterized in that the fill level of the solid, liquid or gaseous materials or the weight load of the solid materials to be secured can be adjusted individually according to the anticipated load in the operating angle area or corresponding reactive forces and moments to the environmental influences.

15. Device according to claims 1 to 14, characterized in that it serves, for example, for maintenance, repair, cleaning and/or measuring devices through integration of additional auxiliary devices (6) and/or itself as guide and/or support for additional devices and equipment (8) which are not permanently located in the effective range of the solar module.

16. Solar module arrangement with a device according to one of the preceding claims, wherein the solar module is constructed as absorbing solar module or as reflecting solar module.
